(19) United States
(12) Patent Application Publication
(10) Pub. No.: US 2014/0020857 A1
(43) Pub. Date: Jan. 23, 2014

(54) FREEZE DRIED PULP AND METHOD OF MAKING

(71) Applicant: Mark F. Teasley, Landenberg, PA (US)

(72) Inventor: Mark F. Teasley, Landenberg, PA (US)

(73) Assignee: E I DU PONT DE NEMOURS AND COMPANY, Wilmington, DE (US)

(21) Appl. No.: 13/551,674

(22) Filed: Jul. 18, 2012

(51) Int. Cl. F26B 5/06; D21H 13/26

(52) U.S. Cl. CPC F26B 5/06; D21H 13/26
USPC 162/157.3; 34/289

(57) ABSTRACT

A method for making a dry pulp comprising the steps of
(i) forming a dispersion in water of a pulp comprising polymeric fibers having a tenacity of at least 20 g/dtex, (ii) filtering the dispersion to form a mass of wet pulp having a solids content of from 5 to 60%, (iii) freezing the wet pulp until the mass is at least 95% frozen, (iv) subliming the water from the frozen mass by subjecting the frozen mass to vacuum of less than 4.5 Torr until the final moisture content of the pulp is no greater than 5% and (v) warming the pulp to ambient temperature under vacuum.

### BACKGROUND

1. Field of the Invention

This invention pertains to a method of making a pulp comprising para-aramid fibers.

2. Description of Related Art

U.S. Pat. No. 8,110,129 to Kurino at al describes a method for obtaining para-type wholly aromatic polyamide particles comprising the steps of (a) introducing an aramid polymer solution into a water-based coagulating liquid to obtain a hydrous shaped product and (b) subjecting the never-dried or partly-dried shaped product having a water content of 10 to 99% by weight to freeze-grinding. These aramid polymer particles can be used as a filler material.

Chinese patent application number 1952226A to Song relates to a para-aramid fibrid and a manufacturing method wherein para-aramid stock solution and a precipitation solvent are transmitted to precipitation equipment and mixed at a low temperature until the stock solution is frozen. Ultra short fiber is produced by the shearing action during mixing and precipitation. Solvent is removed to give a dry fiber. The para-aramid fibrids may be used to make a paper used for electrical insulation.

### SUMMARY OF THE INVENTION

This invention pertains to a method for making a dry pulp comprising the steps of

(i) forming a dispersion in water of a pulp comprising polymeric fibers having a tenacity of at least 20 g/dtex,

(ii) filtering the dispersion to form a mass of wet pulp having a solids content of from 5 to 60%,

(iii) freezing the wet pulp until the mass is at least 95% frozen,

(iv) subliming the water from the frozen mass by subjecting the frozen mass to vacuum of less than 4.5 Torr until the final moisture content of the pulp is no greater than 5%, and

(v) warming the pulp to ambient temperature under vacuum.

### DETAILED DESCRIPTION

### Pulp

Pulp is a highly fibrillated fiber product that is manufactured from yarn by chopping into staple then mechanically abrading in water to partially shatter the fibers. Para-aramid fibers are particularly suited for the manufacture of pulp due to their high tenacity and fibrillar morphology. U.S. Pat. Nos. 5,084,136 and 5,171,402 describe such para-aramid pulps. Para-aramid fiber products are available under the registered trademark Kevlar® from E. I. Du Pont de Nemours and Company, Wilmington, Del. (DuPont). Para-aramid fibers are converted into pulp to give a large increase in surface area as fibrils with diameters as low as 0.1 micrometer are attached to the surface of the main fibers, which are typically 12 micrometers in diameter. Typically, para-aramid pulp has a specific surface area of from 7 to 11 m²/g although values in the range of 4.2 to 15 m²/g have been reported. Para-aramid pulp must be kept moist to prevent the fibrillar morphology from collapsing if the pulp is to be highly dispersible in water or different matrices. Preferably, the pulp fiber length is in the range of from 0.5 to 1.1 mm or even in the range of from 0.6 to 0.8 mm when determined as a Kajaani weight average length.

Para-aramid fibers and pulps can be converted into micropulps by wet milling to increase their surface area as described in US patent application publication US 2003/0114641 A1. Typically, micropulp has a specific surface area of from 15 to 80 m²/g with a fiber length of from 10 to 100 micrometers.

Para-aramid pulps are used as fillers in elastomer compounds to modify their tensile properties. The largest application is in natural rubber for tire reinforcement. The moist pulps are dispersed into water and mixed with elastomer latexes then coagulated to give concentrated masterbatches such as Kevlar® Engineered Elastomer (EE). The EE masterbatches contain the pulp in a highly dispersed state that can be compounded into bulk elastomer to give the desired level of pulp modification. This process is further described in U.S. Pat. Nos. 5,830,395 and 6,068,922. Dry pulps are difficult to disperse directly into elastomers and tend to remain agglomerated. There is a need for a dry pulp with a high level of dispersibility in applications requiring high quality dispersions, while maintaining the required tensile properties when used as fillers. One route to addressing this need is to provide a dry pulp having a higher surface area.

### Polymer

Para-aramid is a suitable polymer for the fibers of the pulp. The term “aramid” means a polyamide wherein at least 85% of the amide (—CONN—) linkages are attached directly to two aromatic rings. Suitable aramid fibers are described in Man-Made Fibres-Science and Technology, Volume 2, Section titled Fibre-Forming Aromatic Polyamides, page 297, W. Black et al., Interscience Publishers, 1968.

A preferred para-aramid is poly(p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Another suitable fiber is one based on aromatic copolyamide prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl) benzimidazole with terephthalic acid or anhydrides or acid chloride derivatives of these monomers.

Para-aramid fibers are spun from liquid crystalline solutions in sulfuric acid by passing through an air-gap and coagulating in water to give a highly oriented fibrillar morphology that promotes the formation of pulp. The coagulated fibers, which are known as “never dried”, contain significant amounts of water before drying into the finished high tenacity product. Other high-tenacity fibers spun from liquid crystalline solutions such as polyazoles should also fibrillate into pulp and be amenable to freeze-drying. Examples of these materials include poly (p-phenylene benzobisoxazole (PBO), or poly (p-phenylene benzobisthiazole) (PBZT). Any high-tenacity fiber with a fibrillar morphology should also give pulps that are amenable to freeze-drying including gel-spun ultra-high molecular weight polyethylene (UHMWPE) fibers. In preferred embodiments, the pulp is made from polymeric fibers having a tenacity of at least 20 g/dtex (18 g/denier).

### Method to Increase Surface Area of Pulp

It has been found that the surface area of a dry fibrous para-aramid pulp can be increased by subjecting the wet pulp to a freeze drying process. Such a method comprises the steps of

(i) forming a dispersion in water of a pulp comprising polymeric fibers having a tenacity of at least 20 g/dtex,

(ii) filtering the dispersion to form a mass of wet pulp having a solids content of from 5 to 60%,

(iii) freezing the wet pulp until the mass is at least 95% frozen,

(iv) subliming the water from the frozen mass by subjecting the frozen mass to vacuum of less than 4.5 Torr until the final moisture content of the pulp is no greater than 5%, and

(v) warming the pulp to ambient temperature under vacuum.

There are no special requirements for the type of water to be used, for example hot tap water is suitable, but deionized water is preferred to minimize any depression in the freezing point of water. The dispersion can be formed during the original pulp manufacturing process or by re-dispersing the moist pulp from that process into water so that no pulp particles remain agglomerated. Micropulp or a micropulp dispersion may also be used. The pulp or micropulp may also be made from never-dried filaments or yarns. After filtering the dispersion to form a filter cake of wet pulp, the fiber mass may be compressed or aspirated to remove excess water. Preferably the fiber (solids) content of the wet pulp is from 5 to 60 weight percent. More preferably, the fiber content of the wet pulp is from 10 to 30 weight percent.

With laboratory freeze-drying apparatuses, the pulp can be contained in a flask or jar that is connected to a vacuum manifold, or placed on a tray in temperature-controlled vacuum chamber. Other configurations are possible for larger scale operations. In any configuration, the water that sublimes from the frozen mass of pulp under vacuum is condensed into a chilled trap, typically at a temperature of −50 degrees C. or lower to maintain a low vapor pressure of water. The wet pulp may be frozen by any convenient means as long as the majority of the water is frozen to ensure the sublimation of water from the frozen mass rather than melting. Such means include placing the wet pulp in a flask or jar in a refrigerated chamber or on a tray in a temperature-controlled chamber at a temperature of zero degrees C. or lower. Preferably the temperature is −40 degrees C. or lower. Another suitable means is cryogenic cooling such as with a chilled heat transfer fluid, liquid nitrogen, or dry ice. Preferably the fiber mass should be at least 95 percent or even 98 percent frozen. The fiber mass is maintained in the frozen state during the drying steps due to the removal of latent heat with the sublimation of water. The temperature of the frozen mass is dictated by the applied vacuum and the resulting vapor pressure of water. In some embodiments, the applied vacuum during the sublimation phase is no greater than 0.5 Torr, preferably in the range of from 0.5 to 0.2 Torr and the temperature of the frozen mass is about −25 to −33 degrees C. Any suitable means of warming the pulp back to ambient temperature may be used. Typically, the pulp on a vacuum manifold simply receives its heat from the environment by conduction or radiation, while the pulp on a tray receives it from the temperature-controlled vacuum chamber. In some embodiments, the tray is heated to drive off any residual moisture still adsorbed on the dry pulp. Preferably, the final moisture content in the dry pulp should be no greater than 3 weight percent, more preferably no greater than 2 weight percent.

### Test Methods

The specific surface areas were measured by nitrogen adsorption/desorption at liquid nitrogen temperature (77.3 K) using a Micromeritics ASAP 2405 porosimeter. Samples were out-gassed overnight at a temperature of 150° C., unless noted otherwise, prior to the measurements and the weight losses were determined due to adsorbed moisture. A five-point nitrogen adsorption isotherm was collected over a range of relative pressures, P/P₀, from 0.05 to 0.20 and analyzed according to the BET method (S. Brunauer, P. H. Emmett, and E. Teller, J. Am. Chem. Soc. 1938, 60, 309); P is the equilibrium gas pressure above the sample, P₀ is the saturation gas pressure of the sample, typically greater than 760 Torr.

The tensile stress-strain measurements were performed according to ASTM D412-06a, Method A, using an extensometer. Dumbell tensile bars were cut using Die C as described in Method A. The tensile results are reported as the average of six samples.

### EXAMPLES

Abbreviations used in the examples and tables are as follows: BET (Brunauer-Emmett-Teller specific surface area), wt (weight), T (temperature), MD (machine direction), XD (cross-machine direction), phr (parts per hundred rubber).

The examples were prepared using the following materials: Alcogum® 6940 thickener (polyacrylic acid, sodium salt; 11% solids) and Alcogum® SL 70 dispersing agent (acrylate copolymer; 30% solids), Akzo Nobel Surface Chemistry, Chattanooga, Tenn.; Aquamix™ 125 (Wingstay® L, hindered polymeric phenolic antioxidant, 50% solids) and Aquamix™ 549 (zinc 2-mercaptotoluimidazole, 50% solids) dispersions, PolylOne Corp., Massillon, Ohio; Amax® accelerator (N-oxydiethylene-2-benzothiazole-sulfenamide) and AgeRite® Resin D antioxidant (polymerized 1,2-dihydro-2,2,4-trimethylquinoline), R. T. Vanderbilt Co., Norwalk, Conn.; DPG accelerator (diphenyl guanidine), Akrochem Corp., Akron, Ohio; Santoflex® 6PPD antiozonant (N-(1,3-dimethylbutyl)-N′-phenyl-Para-phenylenediamine), Solutia/Flexsys® America, Akron, Ohio. Kevlar® pulp 1F361 (BET 7-9 m²/g, 1.0-1.1 mm fiber length), never-dried pulp (0.97 mm fiber length), and micropulp (33 micrometers fiber length) were obtained from DuPont.

The following examples are given to illustrate the invention and should not be interpreted as limiting it in any way. All parts and percentages are by weight unless otherwise indicated. Examples prepared according to the process or processes of the current invention are indicated by numerical values. Control or Comparative Examples are indicated by letters. Data and test results relating to the Comparative and Inventive Examples are shown in Tables 1 to 9.

### Example 1

Kevlar® pulp 1F361 (86 g, 58% solids) was dispersed in 3.5 L hot water using a high-shear mixer (IKA Ultra-Turrax Model SD-45) to give a smooth slurry (1.4% solids). About 350 mL of the slurry was vacuum filtered to give a mass of wet pulp that was then washed with deionized water. The wet pulp was aspirated to remove the excess moisture. A small sample was taken (1.204 g) and dried at 80° C. in a vacuum oven under nitrogen purge to give 0.526 g dry pulp, which indicated 43.7% solids for the wet pulp. A second sample was air dried overnight then dried in a cool vacuum oven under nitrogen purge. The remainder of the wet pulp was placed in a 500 mL round bottom flask and frozen by immersing the flask in liquid nitrogen. The flask was attached to a dry-ice condenser and placed under high vacuum. The pulp remained cold while the water was subliming from the frozen mass, but slowly warmed to room temperature as the sublimation was finishing. The pulp was then was dried overnight under high vacuum. The specific surface area of the samples was measured as shown in the Table 1 below.

TABLE 1

| Sample | BET, m²/g | % wt loss | T, ° C. |
|---|---|---|---|
| Oven-dried | 8.0 | 2.8 | 150 |
| Oven-dried | 7.5 | 2.2 | 100 |
| Air-dried | 8.4 | 2.9 | 150 |
| Freeze-dried | 12.0 | 1.5 | 150 |
| Freeze-dried | 12.3 | 2.2 | 100 |

### Example 2

Another portion of the pulp slurry of Example 1 (about 1100 mL) was vacuum filtered to give a mass of wet pulp and washed with deionized water. The wet pulp was broken into chunks and placed in a 1 L round bottom flask. The flask was placed in dry ice to freeze the wet pulp overnight. The flask was attached to a dry-ice condenser and placed under high vacuum (30 mTorr) over the course of 2.5 working days. The flask was placed in dry ice to keep the pulp frozen while clearing the condenser of moisture or to store overnight. The pulp slowly warmed to room temperature as the water finished subliming from the frozen mass. The pulp was finished by drying under high vacuum overnight to give 15.7 g. The specific surface area was measured as shown in the Table 2 below.

TABLE 2

| BET, m²/g | % wt loss | T, ° C. |
|---|---|---|
| 13.7 | 1.7 | 150 |
| 15.0 | 1.5 | 100 |

### Example 3

Another portion of the pulp slurry of Example 1 (about 1750 mL) was vacuum filtered to give a mass of wet pulp and washed with deionized water. The wet pulp was broken into chunks and placed in a 1 L round bottom flask. The flask was placed in a So-Low ultra-low freezer (−40° C.) to freeze the wet pulp overnight. The flask was attached to a dry-ice condenser and placed under high vacuum (30 mTorr) over the course of 3 working days. The flask was placed in the freezer to keep the pulp frozen while clearing the condenser of moisture or to store overnight. The pulp slowly warmed to room temperature as the water finished subliming from the frozen mass. The pulp was finished by drying under high vacuum overnight. A portion of the freeze-dried pulp was reserved for preparing rubber compounds. The specific surface area was measured as shown in the Table 3 below.

Another portion of the freeze-dried pulp (6.4 g) was redispersed into deionized water (500 mL) heated to 60° C. using the high shear mixer. The quality of the redispersed pulp slurry was visually similar to the starting slurry. The pulp was filtered and refreeze-dried as before. The specific surface area was measured as shown in Table 3 below.

TABLE 3

| Sample | BET, m²/g | % wt loss |
|---|---|---|
| Freeze-dried | 15.3 | 1.9 |
| Freeze-dried 2X | 15.0 | 0.8 |

### Comparative Example A

Kevlar® pulp 1F361 (40 g, 50% solids) was dispersed in water (1000 g) using a laboratory blender to give a homogeneous slurry. Alcogum® 6940 (10 g, 11% solids), Alcogum® SL 70 (2.2 g, 15% solids), Aquamix® 549 (4.1 g, 15% solids), and Aquamix® 125 (4.3 g, 14.5 solids) were added to the blender and dispersed into the slurry. Natural rubber latex (108 g, 62% solids) was added to the blender and dispersed into the slurry. The slurry was poured into an open container and the blender jar was rinsed with water to collect all of the slurry. The latex was coagulated by adding an aqueous solution containing calcium chloride (26 wt %) and acetic acid (5.2 wt %) with gentle stirring until the pH was between 5.8 and 5.2. The coagulated mass was collected and pressed to remove as much of the aqueous phase as possible. The mass was then dried overnight at 70° C. in a vacuum oven under nitrogen purge to give a natural rubber masterbatch containing 23% pulp.

A rubber compound containing 5 phr pulp was prepared by adding the following materials to a C. W. Brabender Prep-Mixer®: natural rubber (192.5 g), the masterbatch (50.25 g), stearic acid (6.94 g, 3 phr), zinc oxide (6.94 g, 3 phr), rubbermaker's sulfur (3.70 g, 1.6 phr), Amax® (1.85 g, 0.8 phr), DPG (0.92 g, 0.4 phr), Santoflex® 6PPD (4.62 g, 2 phr), and AgeRite® Resin D (2.31 g, 1 phr). The compound was mixed at 80-95° C. for 25-30 minutes at 75-100 rpm, then removed from the mixing chamber and blades. The compound was mixed further and homogenized using an EEMCO 2 roll laboratory mill with 6 inch by 12 inch wide rolls. The final compound was sheeted to a thickness of 2.0-2.2 mm. Two 4 inch by 6 inch plaques were cut from the milled sheet in the machine direction, and another two plaques were cut in the cross-machine direction. Machine direction and cross-machine direction are terms well known in the art. The plaques were compression molded at 160° C. to cure the natural rubber.

Dumbell tensile bars were cut from the cured plaques. The tensile properties are shown in Table 4.

TABLE 4

| | Example | | | |
|---|---|---|---|---|
| | 4 | 4 | A | A |
| Test Direction | MD | XD | MD | XD |
| Stress, 10% Strain (MPa) | 0.56 | 0.57 | 0.49 | 0.57 |
| Stress, 25% Strain (MPa) | 1.4 | 1.4 | 1.2 | 1.4 |
| Stress, 50% Strain (MPa) | 3.0 | 2.5 | 2.5 | 2.4 |
| Stress, 100% Strain (MPa) | 4.3 | 3.5 | 3.9 | 3.4 |
| Stress, 200% Strain (MPa) | 5.1 | 4.4 | 4.8 | 4.4 |
| Stress, 300% Strain (MPa) | 5.6 | 5.5 | 6.0 | 5.6 |
| Strain at Break, % | 353 | 480 | 459 | 511 |

### Example 4

The procedure of Comparative Example A was modified to prepare a natural rubber masterbatch containing 23% of the freeze-dried pulp of Example 3 (13 g) by adjusting the required quantities of the other materials. The rubber compound was then made and tested as described in Comparative Example A. The tensile properties are presented in Table 4 show that the tensile properties for rubber compounds from the freeze-dried pulp and the conventional wet pulp are similar, which is surprising since regular dry pulp does not typically disperse well in the disclosed process.

### Example 5

Kevlar® pulp 1F361 (90 g, 56% solids) was dispersed in 3.5 L deionized water heated to 60° C. using the high-shear mixer to give a smooth slurry (1.4% solids). About 1200 mL of the slurry was vacuum filtered to give a mass of wet pulp that was then washed with deionized water. The wet pulp was not compressed or aspirated to remove excess moisture. The wet pulp was broken into chunks and placed in a 1 L round bottom flask. The flask was placed in the ultra-low freezer (−40° C.) to freeze the wet pulp overnight. The flask was attached to a dry-ice condenser and placed under high vacuum (30 mTorr) over the course of 7 working days. The flask was placed in the freezer to keep the pulp frozen while clearing the condenser of moisture or to store overnight. The pulp slowly warmed to room temperature as the water finished subliming from the frozen mass. The pulp was finished by drying under high vacuum overnight to give 17.76 g. The specific surface area was 18.4 m²/g after a weight loss of 2.1%.

### Example 6

Another portion of the pulp slurry of Example 5 (about 2200 mL) was redispersed with the high shear mixer and vacuum filtered to give a mass of wet pulp that was then washed with deionized water. The wet pulp was not compressed or aspirated to remove excess moisture. The wet pulp was broken into chunks and placed in a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum (30 mTorr). The jar was placed in the freezer to keep the pulp frozen only while clearing the trap of moisture. The pulp slowly warmed to room temperature as the water finished subliming from the frozen mass. The pulp was finished by drying under high vacuum overnight to give 32 g. The specific surface area was 16.4 m²/g after a weight loss of 1.8%.

### Example 7

Kevlar® pulp 1F361 (15.1 g, 56% solids) was placed directly into a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 8.6 g. The specific surface area was measured as shown in Table 5 below.

### Example 8

Kevlar® pulp 1F361 (90 g, 56% solids) was dispersed in 3.5 L deionized water heated to 60° C. using the high-shear mixer to give a smooth slurry (1.4% solids). About 1200 mL of the slurry was vacuum filtered to give a mass of wet pulp that was then washed with deionized water. The wet pulp was not compressed or aspirated to remove excess moisture. The wet pulp (61 g) was broken into chunks and placed in a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 16.2 g indicating that the wet pulp was originally about 27% solids. The specific surface area was measured as shown in Table 5 below.

TABLE 5

| Example | Solids, wt % | BET, m²/g | % wt loss |
|---|---|---|---|
| 7 | 56 | 14.0 | 1.3 |
| 8 | 27 | 17.3 | 1.6 |

### Example 9

Another portion of the pulp slurry of Example 8 (about 2400 mL) was vacuum filtered to give a mass of wet pulp that was then washed with deionized water. The wet pulp was not compressed or aspirated to remove excess moisture. The wet pulp (377 g) was broken into chunks and placed in two wide-mouth vacuum jars. Each jar was placed in the ultra-low freezer (−40° C.) to freeze the wet pulp overnight. The jars were attached to continuous freeze-dryers with dry-ice cooled traps and placed under high vacuum. The jars were placed in the freezer to keep the pulps frozen only while clearing the traps of moisture. The pulps slowly warmed to room temperature as the water finished subliming from the frozen masses. The pulps were finished by drying under high vacuum overnight to give a total of 36.0 g indicating that the wet pulp was originally about 9.5% solids. The specific surface areas were 14.3 and 13.9 m²/g after a weight loss of 2.7 and 1.6%, respectively.

### Example 10

Kevlar® pulp 1F361 (99 g, 56% solids) was dispersed in 3.5 L deionized water heated to 60° C. using the high-shear mixer for 5 minutes to give a smooth slurry (1.6% solids). The slurry was vacuum filtered to give a mass of wet pulp that was then washed with deionized water. The wet pulp was not compressed or aspirated to remove excess moisture. The wet pulp (203 g) was broken into chunks and placed in a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 55.5 g indicating that the wet pulp was originally about 27% solids. The specific surface area was 16.3 m²/g after a weight loss of 3.7%.

### Example 11

The procedure of Example 4 was repeated using the freeze-dried pulp of Example 10. The tensile properties are shown in Table 6.

### Comparative Example B

The procedure of Comparative Example A was repeated at the same time as Example 11 to generate a comparative sample. The tensile properties presented in Table 6 show that the tensile properties for rubber compounds from the freeze-dried pulp and the conventional wet pulp are similar, which is surprising since regular dry pulp does not typically disperse well in the disclosed process.

TABLE 6

Example

| | 11 | 11 | B | B |
|---|---|---|---|---|
| Test Direction | MD | XD | MD | XD |
| Stress, 10% Strain (MPa) | 0.74 | 0.42 | 0.75 | 0.45 |
| Stress, 25% Strain (MPa) | 2.0 | 1.0 | 1.9 | 1.0 |
| Stress, 50% Strain (MPa) | 3.8 | 1.7 | 3.6 | 1.9 |
| Stress, 100% Strain (MPa) | 4.8 | 2.7 | 4.6 | 2.8 |
| Stress, 200% Strain (MPa) | 5.6 | 3.8 | 5.5 | 3.9 |
| Stress, 300% Strain (MPa) | 7.4 | 5.1 | 6.8 | 5.0 |
| Strain at Break, % | 325 | 508 | 346 | 529 |

### Example 12

Kevlar® pulp 1F361 (99 g, 51% solids) was dispersed in 3.5 L deionized water heated to 60° C. using the high-shear mixer for 5 minutes to give a smooth slurry (1.4% solids). About 1200 mL of the slurry was vacuum filtered to give a mass of wet pulp that was then washed with deionized water. The wet pulp was not compressed or aspirated to remove excess moisture. The wet pulp (99 g) was broken into chunks and placed in a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 16.6 g indicating that the wet pulp was originally about 17% solids. The specific surface area was 16.8 m²/g after a weight loss of 1.6%.

### Example 13

Kevlar® pulp 1F361 (108 g, 51% solids) was dispersed in 3.5 L deionized water heated to 60° C. using the high-shear mixer for 6 minutes to give a smooth slurry (1.6% solids). The slurry was vacuum filtered to give a mass of wet pulp that was then washed with deionized water. The wet pulp was redispersed as before, treated with Alcogum® SL-70 (3.0 g) followed by Alcogum® 6940 (27.5 g), and mixed for 3 minutes. The slurry took on a thicker, smoother texture than the previous examples without the Alcogum® additives. The slurry was vacuum filtered to give a mass of wet pulp. The wet pulp was not compressed or aspirated to remove excess moisture. The wet pulp (280 g) was broken into chunks and placed in a wide-mouth vacuum jar. The jar was placed in the ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 55.6 g indicating that the wet pulp was originally about 20% solids. The specific surface area was 15.0 m²/g after a weight loss of 1.3%.

### Example 14

The procedure of Example 4 was repeated using the freeze-dried pulp of Example 13. The tensile properties are shown in Table 7.

### Comparative Example C

The procedure of Comparative Example A was repeated at the same time as Example 14 to generate a comparative sample. The tensile properties presented in Table 7 show that the tensile properties for rubber compounds from the freeze-dried pulp and the conventional wet pulp are similar, which is surprising since regular dry pulp does not typically disperse well in the disclosed process.

TABLE 7

| | Example | | | |
|---|---|---|---|---|
| | 14 | 14 | C | C |
| Test Direction | MD | XD | MD | XD |
| Stress, 10% Strain (MPa) | 0.79 | 0.74 | 0.80 | 0.65 |
| Stress, 25% Strain (MPa) | 1.7 | 1.4 | 1.8 | 1.4 |
| Stress, 50% Strain (MPa) | 3.2 | 2.3 | 3.4 | 2.3 |
| Stress, 100% Strain (MPa) | 4.2 | 3.2 | 4.5 | 3.3 |
| Stress, 200% Strain (MPa) | 5.0 | 4.2 | 5.3 | 4.2 |
| Stress, 300% Strain (MPa) | 5.3 | 4.5 | 6.8 | 5.3 |
| Strain at Break, % | 358 | 395 | 429 | 482 |

Analysis of the surface area of examples of freeze dried pulp compared to non-freeze dried pulp showed that the surface area had increased from a range of from 7 to 11 m²/g to a range of from 12 to 18 m²/g.

### Example 15

Kevlar® never-dried pulp (43 g, 22% solids) was dispersed in 600 ml deionized water heated to 60° C. using a high-shear mixer for 5 minutes to give a smooth slurry containing 1.6% solids. The slurry was vacuum filtered to give a mass of wet pulp that was then washed with deionized water. The wet pulp was not compressed or aspirated to remove excess moisture. A small sample was taken and dried under vacuum at room temperature. The wet pulp (63 g) was placed in a wide-mouth vacuum jar. The jar was placed in an ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 7.79 g dry weight indicating that the wet pulp was originally about 12% solids. The specific surface area of the samples was measured as shown in the Table 8 below.

TABLE 8

| Sample | BET, m²/g | % wt loss |
|---|---|---|
| Vacuum-dried | 5.9 | 2.6 |
| Freeze-dried | 11.4 | 3.2 |

### Example 16

Kevlar® micropulp (117 g, 2.6% solids) was vacuum filtered to give a mass of wet pulp that was then washed with deionized water. The wet pulp was not compressed or aspirated to remove excess moisture. The wet pulp (12.99 g) was placed in a wide-mouth vacuum jar. The jar was placed in an ultra-low freezer (−40° C.) to freeze the wet pulp overnight. The jar was attached to a continuous freeze-dryer with a dry-ice cooled trap and placed under high vacuum. The jar was placed in the freezer to keep the pulp frozen only while clearing the trap of moisture. The pulp slowly warmed to room temperature as the water finished subliming from the frozen mass. The pulp was finished by drying under high vacuum overnight to give 3.06 g dry weight indicating that the wet pulp was originally about 24% solids. A second sample was collected and dried under vacuum at room temperature. The specific surface area of the samples was measured as shown in the Table 9 below.

TABLE 9

| Sample | BET, m²/g | % wt loss |
|---|---|---|
| Freeze-dried | 17.8 | 4.0 |
| Vacuum-dried | 17.8 | 3.4 |

What is claimed:

1. A method for making a dry pulp comprising the steps of
(i) forming a dispersion in water of a pulp comprising polymeric fibers having a tenacity of at least 20 g/dtex,
(ii) filtering the dispersion to form a mass of wet pulp having a solids content of from 5 to 60%,
(iii) freezing the wet pulp until the mass is at least 95% frozen,
(iv) subliming the water from the frozen mass by subjecting the frozen mass to vacuum of less than 4.5 Torr until the final moisture content of the pulp is no greater than 5%, and
(v) warming the pulp to ambient temperature under vacuum.

2. The method of claim 1 wherein the dispersion is filtered to form a mass of wet pulp having a solids content of from 10 to 30%.

3. The method of claim 1 wherein the mass is at least 98% frozen.

4. The method of claim 1 wherein the vacuum is less than 0.5 Torr.

5. The method of claim 1 wherein the final moisture content is no greater than 3%.

6. The method of claim 1 wherein the fibers are para-aramid, aromatic copolyamide, polyazole, or ultra-high molecular weight polyethylene.

7. The method of claim 1 wherein the fiber length is from 0.5 to 1.1 mm.

8. A pulp made by the method of claim 1 wherein the specific surface area is no less than 11 m²/g.

9. A pulp made by the method of claim 8 wherein the specific surface area is no less than 15 m²/g.
